(19) United States
(12) Patent Application Publication
(10) Pub. No.: US 2024/0365003 A1
(43) Pub. Date: Oct. 31, 2024

(54) IMAGE SENSOR CONTROL METHOD AND IMAGE CAPTURING DEVICE

(71) Applicant: MEDIATEK INC., Hsin-Chu (TW)

(72) Inventors: Yan-Shao Liu, Hsinchu City (TW); Yun-Feng Tseng, Hsinchu City (TW); Chi-Cheng Ju, Hsinchu City (TW)

(73) Assignee: MEDIATEK INC., Hsin-Chu (TW)

(21) Appl. No.: 18/648,490

(22) Filed: Apr. 29, 2024

Related U.S. Application Data
(60) Provisional application No. 63/498,858, filed on Apr. 28, 2023.

(51) Int. Cl. H04N 23/667; H04N 25/42; H04N 25/46

(52) U.S. Cl. CPC H04N 23/667; H04N 25/42; H04N 25/46

(57) ABSTRACT

An image capturing device comprising an image sensor and a processing circuit. The processing circuit is configured to perform following steps: (a) outputting first sensing frames by the image sensor in a first mode, wherein a first frame time duration is determined between adjacent ones of the first sensing frames; (b) switching from the first mode to a second mode in a transition time interval; (c) setting the transition time interval such that a difference between the transition time interval and the first frame duration is smaller than a predetermined value; and (d) outputting second sensing frames by the image sensor in the second mode.

### CROSS REFERENCE TO RELATED APPLICATIONS

This application claims the benefit of U.S. Provisional Application No. 63/498,858, filed on Apr. 28, 2023. The content of the application is incorporated herein by reference.

### BACKGROUND

The present application relates to an image sensor control method and an image capturing device, and particularly relates to an image sensor control method and an image capturing device which have smooth switch for different modes.

A conventional camera may operate in different modes, thus need to switch between these modes. However, frame durations of adjacent frames may be inconsistent or frame delay may be generated while switching between different modes. Thus, a new method is needed to improve such issue.

### SUMMARY

One objective of the present application is to provide an image sensor control method which can provide smooth switch for different modes.

Another objective of the present application is to provide an image capturing device which has smooth switch for different modes.

One embodiment of the present application discloses an image sensor control method, applied to an image senor, comprising: (a) outputting first sensing frames by the image sensor in a first mode, wherein a first frame time duration is determined between adjacent ones of the first sensing frames; (b) switching from the first mode to a second mode in a transition time interval; (c) setting the transition time interval such that a difference between the transition time interval and the first frame duration is smaller than a predetermined value; and (d) outputting second sensing frames by the image sensor in the second mode.

Another embodiment of the present application discloses an image capturing device comprising an image sensor and a processing circuit. The processing circuit is configured to perform following steps: (a) outputting first sensing frames by the image sensor in a first mode, wherein a first frame time duration is determined between adjacent ones of the first sensing frames; (b) switching from the first mode to a second mode in a transition time interval; (c) setting the transition time interval such that a difference between the transition time interval and the first frame duration is smaller than a predetermined value; and (d) outputting second sensing frames by the image sensor in the second mode.

In view of above-mentioned embodiments, the frame duration while switching between different modes may be consistent with the previous frame period, thus the mode may be switched more smoothly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image capturing device according to one embodiment of the present application.

FIG. 2 and FIG. 3 are schematic diagrams illustrating image sensor control methods according to different embodiments of the present application.

FIG. 4 is a schematic diagram illustrating a full size mode and a binning mode.

FIG. 5 is a flow chart illustrating an image sensor control method according to one embodiment of the present application.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

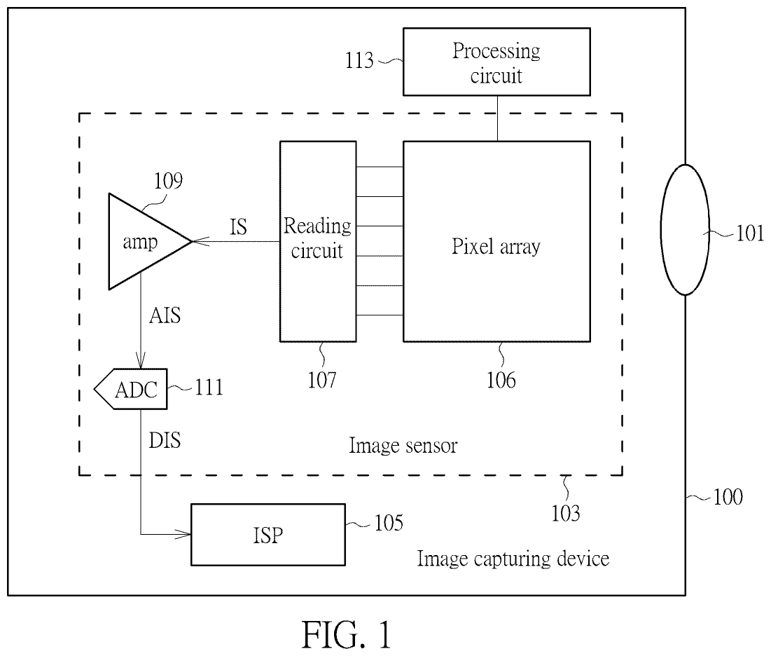

FIG. 1 is a block diagram illustrating an image capturing device 100 according to one embodiment of the present application. It will be appreciated that the methods illustrated in following embodiments is not limited to be implemented by the image capturing device 100 in FIG. 1. In one embodiment, the image capturing device 100 is a camera, and may be an independent electronic device or be integrated to another electronic device such as a mobile phone or a tablet computer.

As shown in FIG. 1, the image capturing device 100 comprises a lens 101, an image sensor 103 and an ISP (image signal processor) 105. The image sensor 103 may comprise a pixel array 106, a reading circuit 107, an image signal amplifying circuit 109, and an ADC 111. The pixel array 106 comprises a plurality of pixels which generate sensing charges corresponding to the received light passing through the lens 101.

The image signal amplifying circuit 109 is configured to amplify the image signal IS to generate an amplified image signal AIS. The amplified image signal AIS is transmitted to an ADC 111 to generate a digital image signal DIS. The digital image signal DIS is transmitted to the ISP 105, which may generate images (frames) according to the digital image signal DIS. In one embodiment, the image capturing device 100 further comprises a processing circuit 113 for setting parameters of the image sensor 106. The processing circuit 113 may be integrated to the image sensor 103.

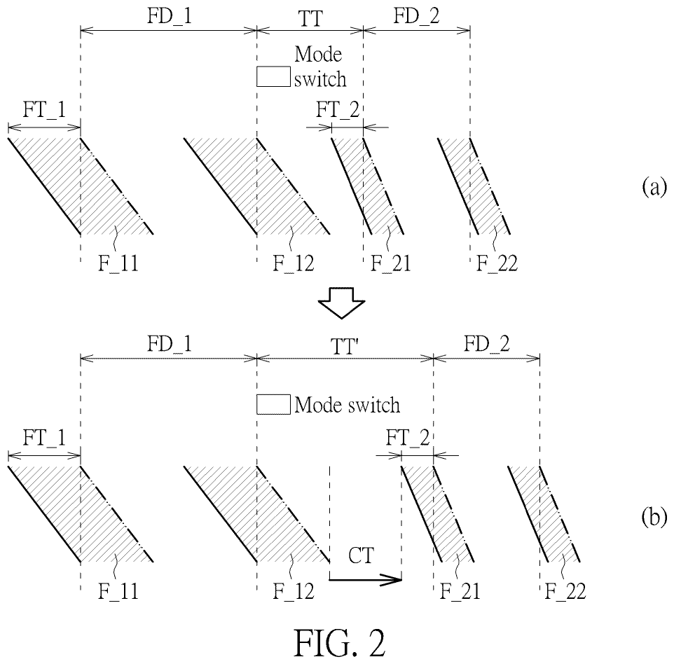

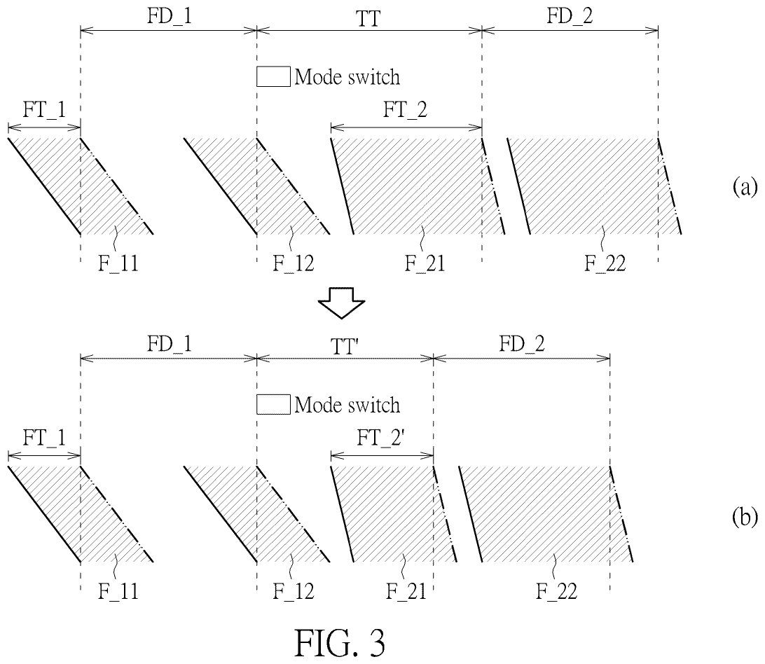

FIG. 2 and FIG. 3 are schematic diagrams illustrating image sensor control methods according to different embodiments of the present application. FIG. 2 comprises drawings FIG. 2 (a) and FIG. 2 (b), and FIG. 3 comprises drawings FIG. 3 (a) and FIG. 3 (b). FIG. 2 (a) and FIG. 3 (a) comprise transition time intervals TT which are not adjusted. On the contrary, FIG. 2 (b) and FIG. 3 (b) comprise transition time intervals TT′ which have been adjusted. In other words, FIG. 2 (a) and FIG. 3 (a) may correspond to related image sensor control methods which do not adjust the transition time intervals TT, and FIG. 2 (b), FIG. 3 (b) correspond to the steps of setting transition time intervals TT′, which are comprised in the image sensor control methods according to different embodiments of the present application.

In the embodiment of FIG. 2 (a), the image sensor 103 outputs first sensing frames F_11, F_12 in a first mode, and switches from the first mode to the second mode in a transition time interval TT. In one embodiment, the first sensing frame F_12 is readout by the reading circuit 107 at a starting time point of the transition time interval TT and the second sensing frame F_21 is readout by the reading circuit 107 at an end time point of the transition time interval TT. No other frames besides the first sensing frame F_12 and the second sensing frame F_21 are readout in the transition time interval TT. Accordingly, the transition time interval TT is equal to “readout time of the first frame F_12+a second frame time interval FT_2 of the second frame F_21”. The first frame time interval FT_1 means the time interval between the starting of sensing the first sensing frame (e.g., sensed by the pixel array 106) and a starting of readout of the first sensing frame. Also, the second frame time interval FT_2 means the time interval between the starting of sensing the second sensing frame and the readout of the second sensing frame. Only one first frame time interval FT_1 and one second frame time interval FT_2 are symbolized for explaining in following embodiments. After that, the image sensor 103 outputs second sensing frames F_21, F_22 in a second mode.

In FIG. 2 (b), the transition time interval is set by the processing circuit 113 such that a difference between the transition time interval and a first frame duration between adjacent first sensing frames (e.g., the first sensing frames F_11, F_12) is smaller than a predetermined value. Specifically, as shown in FIG. 2 (b), the first frame duration FD_1 is determined by a time interval between readout of two adjacent first sensing frames. In one embodiment, the predetermined value is 0, which means the transition time interval TT is adjusted to be equal to the first frame duration FD_1.

As above-mentioned, the transition time interval TT is equal to “readout time of the first frame F_12+the second frame time interval FT_2”. Therefore, in the embodiment of FIG. 2 (b), a second frame time interval FT_2 of each of the second sensing frame F_21, F_22, F_22 is smaller, and causes the transition time interval TT to be smaller than the first frame duration FD_1. Accordingly, the transition time interval TT may be adjusted to be closer to the first frame time duration FD_1 if the first frame time duration FD_1, the readout time and the second frame time interval FT_2 are acquired.

In the embodiment of FIG. 2 (b), the step of setting the transition time interval comprises: acquiring the readout time, the first frame time duration FD land the second frame time interval FT_2; and adjusting the original transition time interval (e.g., the transition time interval TT) to a transition time interval (e.g., the transition time interval TT′) according to the readout time, the second frame time interval FT_2 and the first frame time duration FD_1. In such case, a compensation time CT maybe added after the readout of the first sensing frame F_12 and before the sensing of the second sensing frame F_21, thus the transition time interval TT is extended to the transition time interval TT′. The transition time interval TT′ may be smaller than or equal to the first frame duration FD_1. By this way, the difference between the transition time interval and the first frame duration FD_1 may be reduced, which can make the mode switch more smoothly.

The step of acquiring the first frame time duration FD_1 and the second frame time interval F_21 may be acquired by a variety of methods. In one embodiment, the parameters are already set to the image sensor 103 before generating the second sensing frames. Accordingly, the image sensor 103 may read the prerecorded parameters to acquire the first frame time duration FD_1 and the second frame time interval FT_2. The acquiring of the readout time may also follow the same way.

After the mode is switched from the first mode to the second mode, the second sensing frames F_21, F_22 are output. As shown in FIG. 2 (b), a second frame duration FD_2 exists between the readout of the second sensing frames F_21 and F_22. The second frame duration FD_2 may be different from the first frame duration FD_1 or the same as the first frame duration FD_1. Please note, the number of the first sensing frames F_11, F_12 and the number of the second sensing frames F_21, F_22 are not limited to the embodiment of FIG. 2.

In FIG. 3 (a), the image sensor 103 outputs first sensing frames F_11, F_12 in a first mode, and switches from the first mode to the second mode in a transition time interval TT. In one embodiment, the first sensing frame F_12 is readout at a starting time point of the transition time interval TT and the second sensing frame F_21 is readout at an end time point of the transition time interval TT. No other frames besides the first sensing frame F_12 and the second sensing frame F_21 are readout in the transition time interval TT. After that, the image sensor 103 outputs second sensing frames F_21, F_22 in a second mode.

In FIG. 3 (b), the transition time interval is set by the processing circuit 113 such that a difference between the transition time interval and a first frame duration between adjacent first sensing is frames smaller than a predetermined value. As above-mentioned, as shown in FIG. 3 (b), the first frame duration FD_1 is determined by a time interval between readout of two adjacent first sensing frames. In one embodiment, the predetermined value is 0, which means the transition time interval is adjusted to be equal to the first frame duration. As above-mentioned, the first frame time interval FT_1 means the time interval between the starting of sensing the first sensing frame (e.g., sensed by the pixel array 106) and the readout of the first sensing frame. Also, the second frame time interval FT_2 means the time interval between the starting of sensing the second sensing frame and the readout of the second sensing frame.

The transition time interval TT maybe equal to “readout time of the first frame F_12+the second frame time interval FT_2”. In the embodiment of FIG. 3 (a), a second frame time interval FT_2 of each of the second sensing frame F_21, F_22 is larger, thus causes the transition time interval TT to be larger than the first frame duration FD_1. Accordingly, the transition time interval TT may be adjusted to be closer to the first frame time duration FD_1 if the first frame time duration FD_1, the readout time and the second frame time interval FT_2 are acquired.

In the embodiment of FIG. 3 (b), the step of setting the transition time interval comprises: acquiring the read out time, the first frame time duration FD_1 and an original second frame time interval (e.g., the second frame time interval FT_2) of each of the second sensing frames; and adjusting the original second frame time interval to a second frame time interval (e.g., the second frame time interval FT_2′) according to the readout time, the first frame time duration FD_1 and the original second frame time interval, thereby the original transition time interval is adjusted to a new transition time interval (e.g., the transition time interval TT′). For example, the second frame time interval FT_2′ is equal to “first frame time duration FD_1—the readout time of the first frame F_12”.

For more detail, the processing circuit 113 reduces the original second frame time interval to the second frame time interval. However, since the exposure time of frames is in proportion to the frame time interval thereof, the brightness of the second sensing frames decrease if the second frame time interval is reduced. Accordingly, the processing circuit 113 may further increase an analog gain (the gain of the amplifier 109), a digital gain (the ADC 111) or a DCG (Dual Conversion Gain) of the image sensor 103 based on the difference between the original second frame time interval and the second frame time interval. By this way, the final brightness of the second can be maintained.

As above-mentioned, the second frame time interval FT_2 of each of the second sensing frame F_21, F_22 is larger, thus the transition time interval TT is larger. Accordingly, the transition time interval TT is decreased to the transition time interval TT′, since the second frame time interval FT_2 is reduced to the second frame time interval FT_2′.

The step of acquiring the first frame time duration and the original second frame time interval may be acquired by a variety of methods. In one embodiment, the parameters are already set to the image sensor 103 before generating the second sensing frames. Accordingly, the image sensor 103 may read the prerecorded parameters to acquire the first frame time duration and the original second frame time interval. The acquiring of the readout time may also follow the same way.

After the mode is switched from the first mode to the second mode, the second sensing frames F_21, F_22 are output. As shown in FIG. 3 (b), a second frame duration FD_2 exists between the output of the second sensing frames F_21 and F_22. The second frame duration FD_2 may be different from the first frame duration FD_1 or the same as the first frame duration FD_1.

The step of setting the transition time interval TT′ may be performed at different time points. In one embodiment, the transition time interval TT′ may be set to the image sensor 103 when the image sensor 103 is not activated, thus the image sensor 103 always switches between the first mode and the second mode using the transition time interval TT′. In another embodiment, the transition time interval may be dynamically set. For example, the image sensor 103 initially uses the transition time interval TT and switches to use the transition time interval TT′ when the image sensor 103 is activated.

As above-mentioned, the above-mentioned first mode and second mode are different modes of the image sensor. In one embodiment, the first mode is a full size mode of the image sensor 103, and the second mode is binning mode of the image sensor 103. For more detail, the full size mode is used when the image capturing device 100 zooms in the previewed images before recording the images. On the contrary, the binning mode is used when the image capturing device 100 zooms out the previewed images.

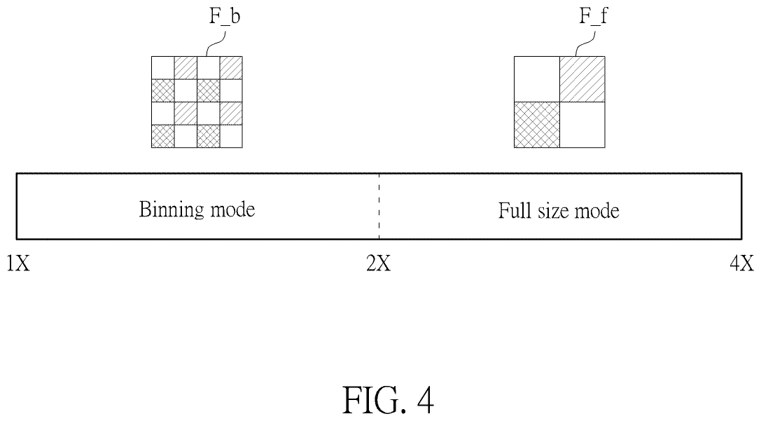

FIG. 4 is a schematic diagram illustrating a full size mode and a binning mode. As shown in FIG. 4, in the full size mode, the frame F_f is an original frame output by the ISP 105 in FIG. 1, which has a high resolution. Also, in the binning mode, the frame F_b is a frame which has binned pixel values and a lower resolution. In the embodiment of FIG. 2, the first mode may be a full size mode and the second mode may be a binning mode. Further, in the embodiment of FIG. 3, the first mode may be a binning mode and the second mode may be a full size mode. In other words, one of the first mode and the second mode is a full size mode and the other one of the first mode and the second mode is a binning mode.

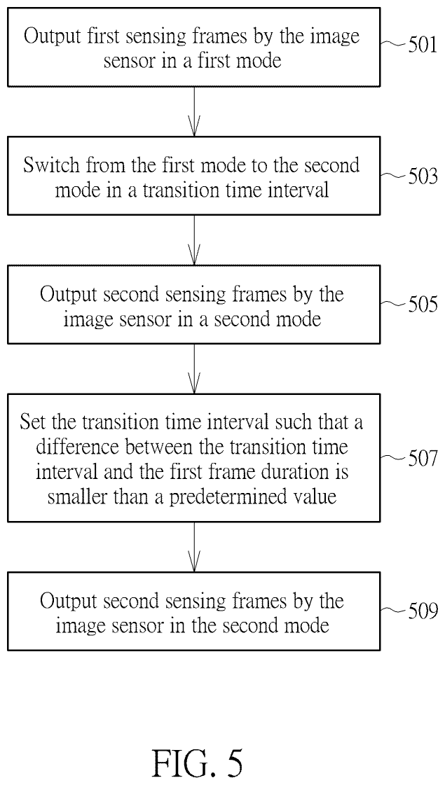

In view of above-mentioned embodiments, an image sensor control method may be acquired. FIG. 5 is a flow chart illustrating an image sensor control method according to one embodiment of the present application. The image sensor control method is applied to an image senor (e.g., the image sensor 103) comprises:

### Step 501

Output first sensing frames (e.g., the first sensing frames F_11, F_12) by the image sensor in a first mode.

A first frame time duration, such as the first frame time duration FD_1, is determined between adjacent ones of the first sensing frames.

### Step 503

Switch from the first mode to the second mode in a transition time interval (e.g., the transition time interval TT or TT′).

### Step 507

Set the transition time interval such that a difference between the transition time interval and the first frame duration is smaller than a predetermined value.

### Step 509

Output second sensing frames (e.g., the second sensing frames F_21, F_22) by the image sensor in the second mode

In view of above-mentioned embodiments, the frame duration while switching between different modes may be consistent with the previous frame period, thus the mode may be switched more smoothly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image sensor control method, applied to an image senor, comprising:
(a) outputting first sensing frames by the image sensor in a first mode, wherein a first frame time duration is determined between adjacent ones of the first sensing frames;
(b) switching from the first mode to a second mode in a transition time interval;
(c) setting the transition time interval such that a difference between the transition time interval and the first frame duration is smaller than a predetermined value; and
(d) outputting second sensing frames by the image sensor in the second mode.

2. The image sensor control method of claim 1, wherein the step (c) comprises:
(c1) acquiring the first frame time duration, a readout time of the first sensing frame and a second frame time interval of each of the second sensing frames; and
(c2) adjusting an original transition time interval to the transition time interval according to the first frame time duration, the readout time of the first sensing frame and the second frame time interval.

3. The image sensor control method of claim 2, wherein a first frame time interval of each of the first sensing frame is larger than the second frame time interval.

4. The image sensor control method of claim 1, wherein one of the first sensing frames is readout at a starting time point of the transition time interval and one of the second sensing frames is readout at an end time point of the transition time interval.

5. The image sensor control method of claim 4, wherein the step (c) comprises:
(c1) acquiring the first frame time duration, a readout time of the first sensing frame and an original second frame time interval of each of the second sensing frames; and
(c2) adjusting the original second frame time interval to a second frame time interval according to the first frame duration, the readout time of the first sensing frame and the original second frame time interval thereby an original transition time interval is adjusted to the transition time interval.

6. The image sensor control method of claim 5, wherein the step (c2) reduces the original second frame time interval to the second frame time interval and increases an analog gain, a digital gain or a DCG (Dual Conversion Gain) of the image sensor based on the difference between the original second frame time interval and the second frame time interval.

7. The image sensor control method of claim 5, wherein a first frame time interval of each of the first sensing frame is smaller than the second frame time interval.

8. The image sensor control method of claim 1, wherein one of the first mode and the second mode is a full size mode and the other one of the first mode and the second mode is a binning mode.

9. The image sensor control method of claim 1, wherein the predetermined value is 0.

10. An image capturing device, comprising:
an image sensor; and
a processing circuit, configured to perform following steps:
(a) controlling the image sensor to output first sensing frames in a first mode, wherein a first frame time duration is determined between adjacent ones of the first sensing frames;
(b) controlling the image sensor to switch from the first mode to the second mode in a transition time interval;
(c) setting the transition time interval such that a difference between the transition time interval and the first frame duration is smaller than a predetermined value; and
(d) outputting second sensing frames by the image sensor in the second mode.

11. The image capturing device of claim 10, wherein the step (c) comprises:
(c1) acquiring the first frame time duration, a readout time of the first sensing frame and a second frame time interval of each of the second sensing frames; and
(c2) adjusting an original transition time interval to the transition time interval according to the first frame time duration, the readout time of the first sensing frame and the second frame time interval.

12. The image capturing device of claim 11, wherein a first frame time interval of each of the first sensing frame is larger than the second frame time interval.

13. The image capturing device of claim 10, wherein one of the first sensing frames is readout at a starting time point of the transition time interval and one of the second sensing frames is readout at an end time point of the transition time interval.

14. The image capturing device of claim 13, wherein the step (c) comprises:
(c1) acquiring the first frame time duration, a readout time of the first sensing frame and an original second frame time interval of each of the second sensing frames; and
(c2) adjusting the original second frame time interval to a second frame time interval according to the first frame duration, the readout time of the first sensing frame and, thereby an original transition time interval is adjusted to the transition time interval.

15. The image capturing device of claim 14, wherein the step (d2) reduces the original second frame time interval to the second frame time interval and increases an analog gain, a digital gain or a DCG (Dual Conversion Gain) of the image sensor based on the difference between the original second frame time interval and the second frame time interval.

16. The image capturing device of claim 14, wherein a first frame time interval of each of the first sensing frame is smaller than the second frame time interval.

17. The image capturing device of claim 10, wherein one of the first mode and the second mode is a full size mode and the other one of the first mode and the second mode is a binning mode.

18. The image capturing device of claim 10, wherein the predetermined value is 0.
